(19) United States
(12) Patent Application Publication
(10) Pub. No.: US 2014/0368958 A1
(43) Pub. Date: Dec. 18, 2014

(54) ELECTROSTATIC PROTECTION CIRCUIT

(71) Applicant: Kabushiki Kaisha Toshiba, Tokyo (JP)

(72) Inventor: Takehito IKIMURA, Kanagawa (JP)

(73) Assignee: KABUSHIKI KAISHA TOSHIBA, Tokyo (JP)

(21) Appl. No.: 14/195,777

(22) Filed: Mar. 3, 2014

(30) Foreign Application Priority Data
Jun. 18, 2013 (JP) 2013-127366

(51) Int. Cl. H02H 9/04

(52) U.S. Cl. CPC H02H 9/044
USPC 361/56

(57) ABSTRACT

An electrostatic protection circuit includes a clamp circuit between a first power source line and a trigger circuit. The clamp circuit has a threshold voltage at which the response to changes in voltage becomes non-linear such that electric current passing through the clamp circuit varies non-linearly. The trigger circuit is connected between the clamp circuit and a second power source line. The trigger circuit outputs a trigger signal to a buffer circuit according to the electric current passing through the clamp circuit. The buffer circuit is configured to output a drive signal to a switch circuit in response to the trigger signal. The switch circuit has a main current path connected between the first power source line and the second power source line, and switches the conduction state of the main current path in response to the drive signal.

### CROSS-REFERENCE TO RELATED APPLICATION

This application is based upon and claims the benefit of priority from Japanese Patent Application No. 2013-127366, filed Jun. 18, 2013, the entire contents of which are incorporated herein by reference.

### FIELD

Embodiments described herein relate generally to an electrostatic protection circuit.

### BACKGROUND

Conventionally, various circuits for protecting against an Electrostatic Discharge (ESD) have been proposed. As used herein, ESD means a discharge of electricity from a person or a machine charged with electricity to a semiconductor device or a discharge of electricity from a semiconductor device charged with electricity to a ground potential or the like.

When an ESD is received by a semiconductor device, an electric charge flows into the semiconductor device from terminals of the semiconductor device, and this electric charge generates a high voltage in the semiconductor device which may thus cause an insulation breakdown in an internal element of the semiconductor device and/or failure of the semiconductor device.

Accordingly, an electrostatic protection circuit is a technique indispensable for a semiconductor integrated circuit.

As a typical example of an electrostatic protection circuit, there has been known an RCT (RC Triggered) MOS circuit. In such a circuit, a series circuit including a resistor and a capacitor is connected between power source terminals, and a MOS transistor for discharge is driven using a voltage at a connection node between the resistor and the capacitor as a trigger signal. However, the RCTMOS circuit also responds to fluctuation of a power source voltage generated when an internal circuit is operated and hence, thus there is a possibility that the MOS transistor for discharge is erroneously operated. The erroneous operation of the MOS transistor for discharge gives rise to a drawback that a power source voltage is lowered such that an operational failure occurs in the internal circuit. For example, the fluctuation of the power source voltage frequently occurs in a vehicle-mounted semiconductor integrated circuit.

### DESCRIPTION OF THE DRAWINGS

FIG. 1 is a diagram of an electrostatic protection circuit according to a first embodiment.

FIG. 2 is a diagram of an electrostatic protection circuit according to a second embodiment.

FIG. 3 is a diagram of an electrostatic protection circuit according to a third embodiment.

FIG. 4 is a diagram of an electrostatic protection circuit according to a fourth embodiment.

FIG. 5 is a diagram of an electrostatic protection circuit according to a fifth embodiment.

FIG. 6 is a graph depicting a result of a simulated operation of the electrostatic protection circuit according to the fifth embodiment.

### DETAILED DESCRIPTION

According to an embodiment, there is provided an electrostatic protection circuit which can suppress an erroneous operation due to the fluctuation of a power source voltage.

In general, according to one embodiment, an electrostatic protection circuit includes: a first power source line, a second power source line, and a first connection node. A clamp circuit is connected between the first power source line and the first connection node. The clamp circuit is configured to have a predetermined threshold voltage at which the electric current passing through the clamp circuit sharply increases. That is, for example, the clamp circuit may have a diode-like current-voltage characteristic response such that the clamp circuit responds to a voltage difference between the first power source line and the first connection node such that the electric current passing through the clamp circuit varies non-linearly upon reaching the threshold voltage. A trigger circuit in the protection circuit is connected between the first connection node and the second power source line. The trigger circuit outputs a trigger signal in response to a change in an electric current passing through the clamp circuit.

A buffer circuit, which is biased by a voltage between the first connection node and the second power source line, outputs a drive signal in response to the trigger signal.

A switch circuit having a main current path that is connected between the first power source line and the second power source line is configured to switch the conduction state of the main current path between turned on and off in accordance with the drive signal.

Hereinafter, electrostatic protection circuits according to embodiments are explained in detail in conjunction with attached drawings. The scope of the disclosure is not limited to these exemplary embodiments.

### First Embodiment

FIG. 1 is a diagram of an electrostatic protection circuit according to the first embodiment. The electrostatic protection circuit of this first embodiment includes a clamp circuit 3, a trigger circuit 4, a buffer circuit 5, and a switch circuit 6. A first power source line 10 is connected to a first power source terminal 1. A predetermined power source voltage VCC, for example, is applied to the first power source line 10. The first power source terminal 1 and first power source line 10 may be referred to as a high potential side. A second power source line 11 is connected to a second power source terminal 2, and a power source voltage is applied to the second power source terminal 2. For example, a ground potential is applied to the second power source terminal 2 as the power source voltage on a low potential side.

The clamp circuit 3 is connected between the first power source line 10 and a first connection node 12. For example, when an ESD surge which is positive with respect to the second power source terminal 2 is applied to the first power source terminal 1 such that a voltage difference between the first power source line 10 and the first connection node 12 exceeds a predetermined threshold, the electric current which flows through the clamp circuit 3 is sharply increased—that is, a plot of voltage (x-axis) vs. current (y-axis) would be steep upon crossing the predetermined threshold voltage.

The trigger circuit 4 is connected between the first connection node 12 and the second power source line 11. The trigger circuit 4 outputs a trigger signal in response to a change in an electric current which flows in the clamp circuit 3.

The buffer circuit 5 is biased by a voltage between the first connection node 12 and the second power source line 11, and outputs a drive signal in response to the trigger signal.

A main current path of switch circuit 6 is connected between the first power source line 10 and the second power source line 11, and the switch circuit 6 switches the conductance state of the main current path between on-state (ON state) and off-state (OFF state) in response to the drive signal. When the main current path becomes conductive (on-state conductance), an ESD surge can be discharged.

An internal circuit 7 is connected between the first power source line 10 and the second power source line 11. Internal circuit 7 can be any circuit protected from ESD surges.

In a steady-state bias state where a predetermined power source voltage is applied between the first power source terminal 1 and the second power source terminal 2, the clamp circuit 3 is in an OFF state, that is, in a state where an electric current does not substantially flow through the clamp circuit 3. In such a steady-state bias state, the trigger signal is not outputted from the trigger circuit 4, and the drive signal for driving the switch circuit 6 is not outputted from the buffer circuit 5. Accordingly, the switch circuit 6 is in an OFF state, that is, in a state where the main current path is not conductive.

Unless a voltage between the first power source line 10 and the first connection node 12 exceeds the predetermined threshold voltage, the clamp circuit 3 maintains an OFF state. The threshold voltage of the clamp circuit 3 is set to a voltage level higher than the expected fluctuation in a power source voltage between the first power source line 10 and the second power source line 11 generated during a normal circuit operation of the internal circuit 7, for example. Such a voltage setting is made to prevent the electrostatic protection circuit from being erroneously operated in response to normal fluctuations of the power source voltage occurring during normal circuit operation of the internal circuit 7.

In this manner, by setting the threshold voltage of the clamp circuit 3 to a voltage level higher than the expected fluctuation of a power source voltage during the normal circuit operation of the internal circuit 7, it is possible to provide a electrostatic protection circuit which does not respond to the normal fluctuations of in power source voltage, but will still respond to an ESD surge.

### Second Embodiment

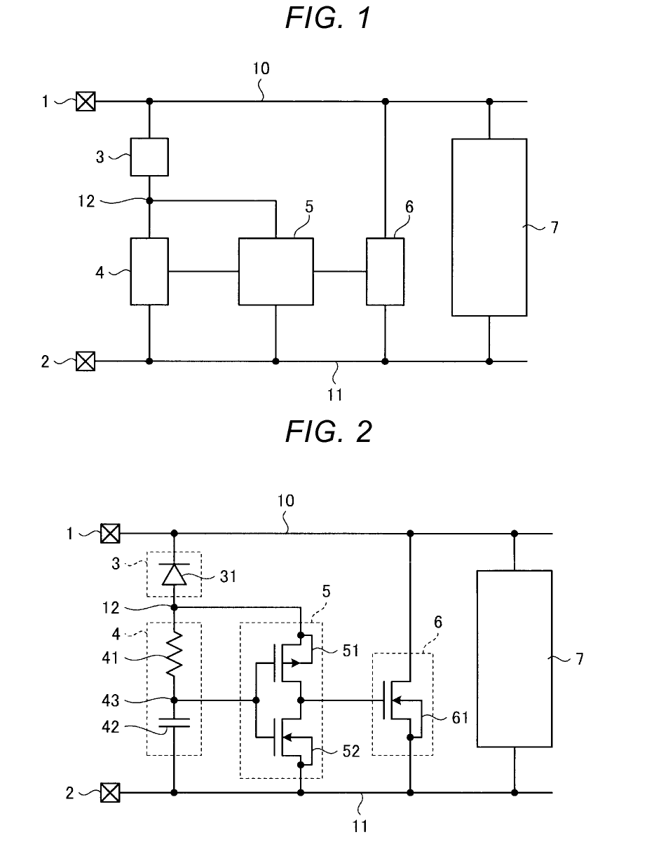

FIG. 2 is a diagram of an electrostatic protection circuit according to the second embodiment. Elements of the second embodiment which correspond to the elements of the first embodiment are given same reference symbols, and the repeated explanation of these elements may be omitted. In this second embodiment, the clamp circuit 3 includes a diode 31 which is reverse biased by a power source voltage applied between the first power source line 10 and the second power source line 11. The trigger circuit 4 which is connected between the first power source line 10 and the first connection node 12 includes a series circuit including a resistor 41 and a capacitor 42. A common connection node 43 of the resistor 41 and the capacitor 42 forms an output end of the trigger circuit 4.

The buffer circuit 5 includes a CMOS inverter comprising a PMOS transistor 51 and an NMOS transistor 52. A gate electrode of the PMOS transistor 51 and a gate electrode of the NMOS transistor 52 are connected to each other, and are connected to the common connection node 43. A source electrode and a back gate electrode of the PMOS transistor 51 are connected to the first connection node 12. A source electrode and a back gate electrode of the NMOS transistor 52 are connected to the second power source line 11. A drain electrode of the PMOS transistor 51 and a drain electrode of the NMOS transistor 52 are commonly connected to each other, and form an output end of the buffer circuit 5.

A waveform of a trigger signal output from the trigger circuit 4 is shaped by the buffer circuit 5, and the waveform-shaped trigger signal from the buffer circuit 5 is supplied to the switch circuit 6.

A source-drain path constituting a main current path of the switch circuit 6 is connected between the first power source line 10 and the second power source line 11, and the switch circuit 6 includes an NMOS transistor 61 having a gate electrode to which an output of the buffer circuit 5 is supplied.

In a steady-state bias state where a predetermined power source voltage is applied between the first power source terminal 1 and the second power source terminal 2, the capacitor 42 is charged with a leakage current from the diode 31 and a potential of the common connection node 43 is at a high level. Accordingly, the output of the buffer circuit 5 is at a low level. A signal of a low level is applied to the gate electrode of NMOS transistor 61, which constitutes the switch circuit 6, such that the switch circuit 6 is brought into an OFF state.

For example, even when the fluctuation of a power source voltage is generated between the first power source line 10 and the second power source line 11 during the operation of the internal circuit 7, an OFF state of the NMOS transistor 61 is maintained within a range in which the fluctuation does not exceed a breakdown voltage of the diode 31. Accordingly, it is possible to avoid a situation where the NMOS transistor 61 is erroneously operated in response to the fluctuation of the power source voltage which is generated between the first power source line 10 and the second power source line 11.

When an ESD surge, which is positive with respect to the second power source terminal 2, is applied to the first power source terminal 1 and the voltage between the first power source line 10 and the first connection node 12 exceeds the breakdown voltage of the diode 31, the diode 31 breaks down and the electric current flowing through the diode and into the trigger circuit 4 increases sharply and substantially. Thus, an electric current passing through the clamp circuit varies non-linearly upon reaching a threshold voltage.

When a voltage drop across the resistor 41 exceeds a threshold value of the CMOS inverter in buffer circuit 5, a signal of a high level is outputted from the buffer circuit 5.

When the signal of a high level is applied to a gate electrode of the switch circuit 6, the NMOS transistor 61 is turned on.

When the NMOS transistor 61 is turned on, an ESD surge is discharged. Thus, when the diode 31 breaks down, the voltage between the first power source line 10 and the first connection node 12 is clamped to the breakdown voltage of the diode 31. Also when the voltage between the first power source line 10 and the first connection node 12 exceeds the breakdown voltage of the diode 31 due to the fluctuations of the power source voltage, the NMOS transistor 61 is turned on in the same manner.

When an ESD surge, which is positive with respect to the first power source terminal 1, is applied to the second power source terminal 2, an ESD surge can be discharged through a parasitic diode (not specifically depicted in the drawing) of the NMOS transistor 61 which is formed by a substrate (or a well formed in the substrate) and a drain region of the NMOS transistor 61.

According to the electrostatic protection circuit of this second embodiment, by properly setting the breakdown voltage of the diode 31, a range within which the power source voltage is allowed to fluctuate can be set. The NMOS transistor 61 (which constitutes the switch circuit 6) is turned on in response to the fluctuation of a power source voltage or an ESD surge which exceeds the set threshold voltage of the clamp circuit 3. When the NMOS transistor 61 is turned on, a protection operation for protecting the internal circuit 7 is performed. For example, by setting a threshold voltage of the clamp circuit 3 to a voltage higher than an expected fluctuation of a power source voltage generated in a normal circuit operation of the internal circuit 7, it is possible to provide the electrostatic protection circuit which is operated in response to an ESD surge while not responding to the normal fluctuation of a power source voltage generated during a normal operation of the internal circuit 7.

The buffer circuit 5 is biased by a power source voltage between the first connection node 12 and the second power source line 11. Accordingly, the buffer circuit 5 is biased only when the clamp circuit 3 is conductive and supplies a drive signal to the NMOS transistor 61 in response to a trigger signal outputted from the trigger circuit 4. According to this embodiment, it is possible to provide the electrostatic protection circuit where an operation of the trigger circuit 4, an operation of the buffer circuit 5, and an operation of the switch circuit 6 can be controlled based on a threshold voltage set in the clamp circuit 3.

### Third Embodiment

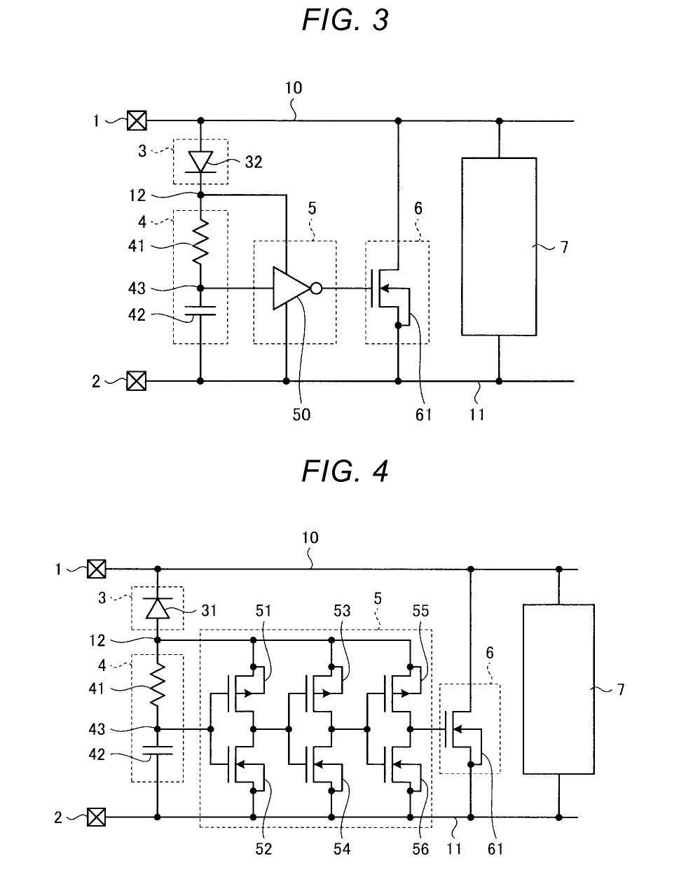

FIG. 3 is a diagram of an electrostatic protection circuit according to the third embodiment. Elements of the third embodiment which correspond to the elements of the previously-explained embodiments are given same reference symbols, and the repeated explanation of these elements may be omitted.

In the electrostatic protection circuit of this third embodiment, the clamp circuit 3, which is connected between the first power source line 10 and the first connection node 12, includes a diode 32 which is forwardly biased by a power source voltage applied between the first power source line 10 and the second power source line 11. The common connection node 43, which constitutes an output end of the trigger circuit 4, is connected to an input end of an inverter 50, which constitutes the buffer circuit 5. The inverter 50 is biased by a voltage applied between the first connection node 12 and the second power source line 11.

In a steady-state bias state where a predetermined power source voltage is applied between the first power source terminal 1 and the second power source terminal 2, the capacitor 42 of the trigger circuit 4 is charged by a minute current which flows through the diode 32 such that a potential of the common connection node 43 is at a high level (i.e., above the voltage potential at power source terminal 2). Accordingly, an output signal of the buffer circuit 5 is at a low level. A signal of a low level is applied to a gate electrode of the NMOS transistor 61, which constitutes the switch circuit 6, so that the NMOS transistor 61 assumes an OFF state. The OFF state of the NMOS transistor 61 is maintained unless a voltage between the first power source line 10 and the first connection node 12 exceeds a forward voltage drop across the diode 32. Accordingly, by properly setting a forward voltage drop of the diode 32, which constitutes the clamp circuit 3, it is possible to avoid a situation where the NMOS transistor 61 is erroneously operated in response to normal fluctuation in a power source voltage applied across the first power source line 10 and the second power source line 11.

On the other hand, when an ESD surge that is positive relative to the second power source terminal 2 is applied to the first power source terminal 1 and a voltage between the first power source line 10 and the first connection node 12 exceeds a forward voltage drop of the diode 32, the electric current flowing through the diode 32 and into the trigger circuit 4 sharply and substantially increases. 4. That is, once the forward voltage across diode 32 exceeds a “cut-in” or “on-voltage,” the apparent resistance of diode 32 to current flow decreases sharply and substantially with additional voltage increases.

When a voltage drop across the resistor 41 exceeds a threshold value of the inverter 50, a signal of a high level is output from the buffer circuit 5.

When the signal of a high level is applied to a gate electrode of the NMOS transistor 61, the NMOS transistor 61, which constitutes the switch circuit 6, is turned on and an ESD surge can be discharged through the NMOS transistor 61.

When current flows through the diode 32, a voltage between the first power source line 10 and the first connection node 12 is clamped to a forward voltage drop of the diode 32.

Also, when a voltage between the first power source line 10 and the first connection node 12 exceeds a forward voltage drop of the diode 32 due to the fluctuation of a power source voltage generated between the first power source line 10 and the second power source line 11, the NMOS transistor 61, which constitutes the switch circuit 6, is turned on in the same manner.

The threshold voltage of the clamp circuit 3 is set to a voltage level higher than the normal (or expected) fluctuation of a power source voltage when the internal circuit 7 operates normally, for example. Such voltage level is set to prevent the electrostatic protection circuit from being erroneously operated in response to the normal fluctuation of a power source voltage.

By setting the threshold voltage of the clamp circuit 3 to a voltage higher than normal fluctuation of the power source voltage during normal circuit operation of the internal circuit 7, it is possible to provide the electrostatic protection circuit in response to an ESD surge while not responding to the normal fluctuation of the power source voltage. For example, a forward voltage drop of a diode is approximately 0.7(V) in general. By properly setting the number of diodes connected in a forward bias state that form the clamp circuit 3, the threshold voltage of the clamp circuit 3 can be adjusted (e.g., in increments of 0.7(V)).

According to the electrostatic protection circuit of this third embodiment, by properly adjusting the number of the diodes 32 in the clamp circuit 3, a threshold voltage of the clamp circuit 3 can be adjusted. By setting the threshold voltage of the clamp circuit 3 to a voltage higher than the fluctuation of a power source voltage generated in a normal operation of the internal circuit 7, it is possible to provide the electrostatic protection circuit which is operated in response to an ESD surge but does not respond to the fluctuation of a normal power source voltage.

Accordingly, it is possible to avoid a situation where the NMOS transistor 61 is erroneously operated in response to the normal fluctuation in a power source voltage applied between the first power source line 10 and the second power source line 11.

### Fourth Embodiment

FIG. 4 is a diagram of an electrostatic protection circuit according to the fourth embodiment. Elements of the fourth embodiment which correspond to the elements of the previously explained embodiments are given same reference symbols, and the repeated explanation of these elements may be omitted.

In the electrostatic protection circuit of this fourth embodiment, the buffer circuit 5 is constituted of CMOS inverters in multiple stages. That is, the buffer circuit 5 includes the CMOS inverters in three stages, including the CMOS inverter that is formed by the PMOS transistor 51 and the NMOS transistor 52, the CMOS inverter that is formed by a PMOS transistor 53 and an NMOS transistor 54, and the CMOS inverter that is formed by a PMOS transistor 55 and an NMOS transistor 56.

According to the electrostatic protection circuit of this fourth embodiment, by properly adjusting a breakdown voltage of diode 31, which constitutes the clamp circuit 3, it is possible to avoid a situation where the NMOS transistor 61, which constitutes the switch circuit 6, is erroneously operated in response to the fluctuation of a power source voltage generated between the first power source line 10 and the second power source line 11.

Further, since the buffer circuit 5 includes the CMOS inverters in multiple stages, the drive capacity of the buffer circuit 5 is enhanced. Accordingly, a MOS transistor having a large output current can be used as the NMOS transistor 61, which constitutes the switch circuit 6. As a result, the ability to discharge an ESD surge can be enhanced.

### Fifth Embodiment

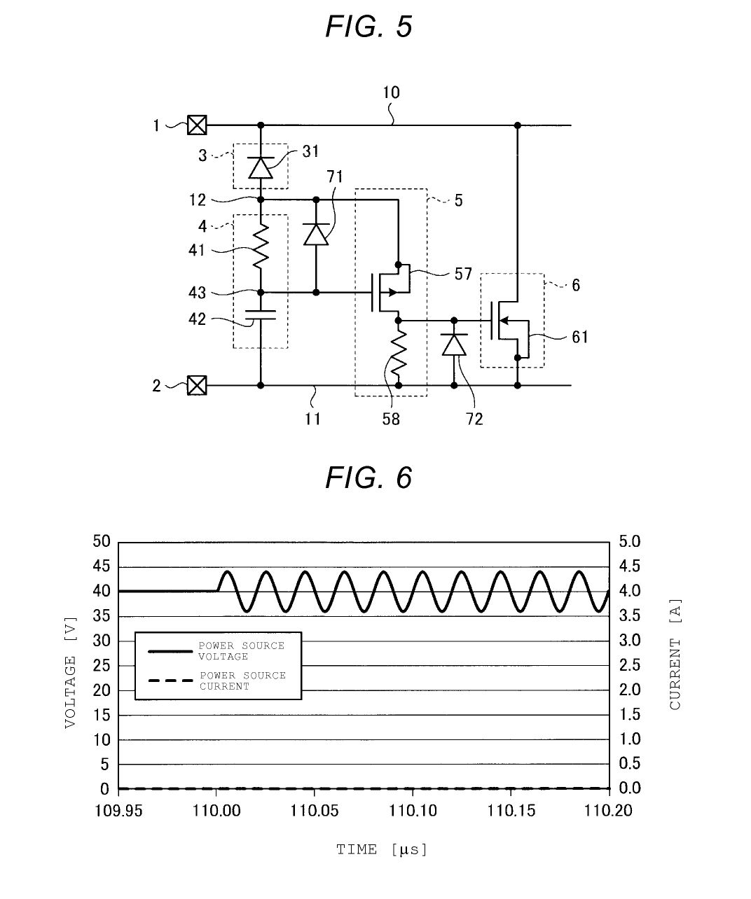

FIG. 5 is a diagram showing an electrostatic protection circuit according to the fifth embodiment. Elements of the fifth embodiment which correspond to the elements of the previously explained embodiments are given same reference symbols, and the repeated explanation of these elements may be omitted. In the electrostatic protection circuit according to this fifth embodiment, an internal circuit (e.g., an internal circuit 7) is omitted.

In this fifth embodiment, the buffer circuit 5 includes a PMOS transistor 57 with a source electrode and a back gate electrode connected to the first connection node 12. A drain electrode of the PMOS transistor 57 is connected to one end of a resistor 58. The other end of the resistor 58 is connected to the second power source line 11. A gate protection diode 71 is connected between a source and a gate of the PMOS transistor 57. A gate protection diode 72 is connected between a source and a gate of the NMOS transistor 61, which constitutes the switch circuit 6.

In a steady-state bias state where a predetermined power source voltage is applied between the first power source terminal 1 and the second power source terminal 2, the capacitor 42 is charged with a leakage current from the diode 31, which is reverse biased, so that a potential of the common connection node 43 of the trigger circuit 4 is at a high level. Accordingly, an output of the buffer circuit 5 is at a low level.

A signal of a low level is applied to a gate electrode of the NMOS transistor 61 so that the NMOS transistor 61 assumes an OFF state. Even when the fluctuation of a voltage between the first power source line 10 and the second power source line 11, the OFF state of the NMOS transistor 61 is maintained as long as the fluctuation level does not exceed the breakdown voltage of the diode 31 in the clamp circuit 3.

On the other hand, when an ESD surge that is positive to the second power source terminal 2 is applied to the first power source terminal 1 such that a voltage between the first power source line 10 and the first connection node 12 exceeds the breakdown voltage of the diode 31, the diode 31 breaks down and an electric current flows into the trigger circuit 4.

When a voltage drop across the resistor 41 exceeds a threshold value of the PMOS transistor 57, the PMOS transistor 57 is turned on and a signal of a high level is output from the buffer circuit 5.

When the signal of a high level is applied to the gate electrode of the NMOS transistor 61, the NMOS transistor 61, which constitutes the switch circuit 6, is turned on and an ESD surge can be discharged.

Also, when a voltage between the first power source line 10 and the first connection node 12 exceeds the breakdown voltage of the diode 31 in response to the fluctuation in a power source voltage, the NMOS transistor 61, which constitutes the switch circuit 6, is turned on in the same manner.

According to the electrostatic protection circuit of this fifth embodiment, by properly setting the breakdown voltage of the diode 31, which constitutes the clamp circuit 3, it is possible to avoid a situation where the NMOS transistor 61, which constitutes the switch circuit 6, is erroneously operated in response to normal fluctuation in the power source voltage.

The gate protection diode 71 is arranged between the source and the gate of the PMOS transistor 57, and the gate protection diode 72 is arranged between the source and the gate of the NMOS transistor 61. Accordingly, even when a power source voltage applied between the first power source terminal 1 and the second power source terminal 2 becomes high, a voltage between the gate and the source of the PMOS transistor 57 and a voltage between the gate and the source of the NMOS transistor 61 are limited by the gate protection diode 72 and hence, breakage of gate oxide films of the transistors can be prevented.

FIG. 6 is a graph showing a result of a simulation of the functioning of an electrostatic protection circuit according to the embodiment shown in FIG. 5. A voltage (the power source voltage) that is applied between the first power source terminal 1 and the second power source terminal 2, and an electric current (the power source current) which flows in the power source line when the power source voltage is applied are both simulated. In this simulation, an internal circuit is not provided.

In this simulation, a fixed power source voltage of 40 volts (V) is applied for 110 microseconds and, thereafter, a fluctuation in the power source voltage with a frequency of 50 MHz and amplitude of 4 volts (V) is applied. A breakdown voltage of the diode 31 is 5 volts (V). As can be seen in the simulation results, the electrostatic protection circuit does not respond to the +/−4 volt fluctuation in the power source voltage. Thus, an erroneous operation of the ESD protection circuit can be prevented.

In some embodiments, the clamp circuit 3 may be formed by combining a diode that is forward biased and a diode that is reverse. A threshold voltage of the clamp circuit 3 can thus be finely adjusted by use of various combinations of diodes in the clamp circuit 3.

In some embodiments, the clamp circuit 3 may comprise a resistor and a diode is not required to be included in clamp circuit 3. That is, it is sufficient for the clamp circuit 3 to have the constitution such that an electric current which flows through the clamp circuit 3 is substantially increased once a predetermined voltage is applied.

The switch circuit 6 may be also formed of a bipolar transistor. When the bipolar transistor is used, a main current path is formed of an emitter-collector path, and a control electrode is formed of a base electrode. In this case, an NPN transistor may be used in place of the NMOS transistor in view of the bias relationship.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrostatic protection circuit, comprising:
a clamp circuit connected between a first power source line and a first connection node, the clamp circuit having a response to a voltage difference between the first power source line and the first connection node such that an electric current passing through the clamp circuit varies non-linearly upon reaching a threshold voltage;
a trigger circuit connected between the first connection node and a second power source line, the trigger circuit configured to output a trigger signal in response to the electric current passing through the clamp circuit;
a buffer circuit that is biased by a voltage between the first connection node and the second power source line, and configured to output a drive signal in response to the trigger signal; and
a switch circuit having a main current path connected between the first power source line and the second power source line, the switch circuit configured to switch the conduction state of the main current path between on and off in response to the drive signal.

2. The electrostatic protection circuit according to claim 1, wherein the trigger circuit includes a resistor and a capacitor connected in series.

3. The electrostatic protection circuit according to claim 1, wherein the clamp circuit includes a diode connected between the first power source line and the first connection node.

4. The electrostatic protection circuit according to claim 3, wherein the diode has an anode connected to the first connection node and a cathode connected to first power source line.

5. The electrostatic protection circuit according to claim 3, wherein the diode has a cathode connected to the first connection node and an anode connected to first power source line.

6. The electrostatic protection circuit according to claim 1, wherein the clamp circuit includes a plurality of diodes connected between the first power source line and the first connection node.

7. The electrostatic protection circuit according to claim 6, wherein at least one of the diodes in the plurality is connected in a reverse biased manner relative to a positive potential applied to the first power source line with respect to the second power source line.

8. The electrostatic protection circuit according to claim 6, wherein at least one of the diodes in the plurality is connected in a forward biased manner relative to a positive potential applied to the first power source line with respect to the second power source line.

9. The electrostatic protection circuit according to claim 1, wherein the clamp circuit includes a resistor.

10. The electrostatic protection circuit according to claim 1, wherein the buffer circuit includes a complementary metal-oxide-semiconductor (CMOS) inverter.

11. The electrostatic protection circuit according to claim 1, wherein the buffer circuit includes:
a transistor having a source-drain path between the first connection node and the second power source line and a gate electrode connected to the trigger signal output from the trigger circuit, and
a gate protection diode connected between the gate electrode and a source electrode of the transistor.

12. The electrostatic protection circuit according to claim 1, wherein the switch circuit includes:
an n-channel metal-oxide-semiconductor (NMOS) transistor having a drain electrode connected to the first power source line, a source electrode and a back gate electrode connected to the second power source line, and a gate electrode connected to the drive signal output from the buffer circuit.

13. The electrostatic protection circuit according to claim 12, wherein a gate protection diode is connected between the gate electrode and the source electrode of the NMOS transistor.

14. A protection circuit connected between a power source and a protected internal circuit, the protection circuit comprising:
a clamp circuit connected between a first power source line at a first power source potential and a first connection node, the clamp circuit having a response to a voltage difference between the first power source line and the first connection node such that an electric current passing through the clamp circuit varies non-linearly upon reaching a threshold voltage;
a trigger circuit connected between the first connection node and a second power source line at a second power source potential, the trigger circuit configured to output a trigger signal from a trigger output node in response to the electric current passing through the clamp circuit;
a buffer circuit having a buffer input node connected to the trigger output node, the buffer circuit biased by a voltage difference between a potential at the first connection node and the second power source potential, and configured to output a drive signal from a buffer output node in response to the trigger signal; and
a switch circuit configured to electrically connect the first power source line to the second power source line in response to the drive signal.

15. The protection circuit according to claim 14, wherein the clamp circuit is a diode.

16. The protection circuit according to claim 15, wherein the switch circuit is a n-channel metal-oxide semiconductor (NMOS) transistor having a source-drain path between the first and second power source lines, a back-gate electrode connected the second power source line, and a gate electrode connected to the buffer output node.

17. The protection circuit according to claim 13, further comprising:
a first gate protection diode connected between the first connection node and the buffer input node; and
a second gate protection node connected between the buffer output node and the second power source line.

18. An electrostatic protection circuit, comprising:
a first diode connected between a first power source line and a first connection node, the first diode having a response to a voltage difference between the first power source line and the first connection node such that an electric current passing through the first diode varies non-linearly upon reaching a threshold voltage;
a trigger circuit connected between the first connection node and a second power source line, the trigger circuit configured to output a trigger signal in response to the electric current passing through the first diode;
a buffer circuit that is biased by a voltage between the first connection node and the second power source line, and configured to output a drive signal in response to the trigger signal; and
a switch circuit having a main current path connected between the first power source line and the second power source line, the switch circuit configured to switch the conduction state of the main current path between on and off in response to the drive signal

19. The electrostatic protection circuit of claim 18, further comprising:
a second diode connected in series with the first diode between the first power source line and the first connection node.

20. The electrostatic protection circuit of claim 19, wherein the first diode is connected in a reverse-bias manner with respect to a positive potential on the first power source line, and the second diode is connected in a forward-bias manner with respect to the positive potential on the first power source line.
